(19) United States
(12) Patent Application Publication
(10) Pub. No.: US 2006/0106955 A1
(43) Pub. Date: May 18, 2006

(54) Method for dynamically adjusting the data transfer order of PCI express root ports

(76) Inventors: Jing-Rung Wang, Hsin-Tien City (TW); Robert Shih, Hsin-Tien City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/213,689

(22) Filed: Aug. 30, 2005

(30) Foreign Application Priority Data
Nov. 12, 2004 (TW) 093134687

(51) Int. Cl. G06F 3/00

(52) U.S. Cl. 710/29

(57) ABSTRACT

A method for dynamically adjusting the data transfer order of the Peripheral Component Interconnect Express (PCI Express) root ports is proposed. The method includes: reading the values of the available storage spaces of the first storage units of the PCI Express root ports and the second storage units of the endpoint devices recorded according to the flow control norm of the PCI Express standard; comparing the values of the available storage spaces of the first and second storage units to find the PCI Express root ports with larger data transfer volume; and updating a port arbitration table to adjust the data transfer order of the PCI Express root ports to make the PCI Express root ports with larger data transfer volume have higher priority for data transfer. Thereby, the flexibility and efficiency of the data transfer of the PCI Express root ports can be improved.

### BACKGROUND OF THE INVENTION

1. Field of the Invention

The present invention is related to an input/output bus of the Peripheral Component Interconnect Express (PCI Express) standard, and more particularly, to a method for dynamically adjusting the data transfer order of PCI Express root ports. This method can be used to dynamically update the port arbitration table according to the flow control norm. Thus, it can improve the flexibility of the data transfer of the PCI Express root ports.

2. Description of Related Art

With the rapid progress of computer systems, the functionality of the computer systems becomes better and better. The best improvement is to combine multimedia services with the present computers. Hence, the data transferred in the computer systems nowadays further includes time-related data such as sound or video data. In order to fit in with time-related attributes, the computer systems should transfer these time-related data in a fixed time period so as to prevent these data from being played intermittently.

In the present, most of the computer systems use the second-generation buses, namely Peripheral Component Interconnect (PCI) buses. In general, the PCI buses can transfer 133 MB data per second. In the PCI standard, multiple peripherals share the same 133 MB bandwidth of the PCI bus and the time-related attributes doesn't be considered. The requirements for transferring the time-related data can be fulfilled only by using the so-called Isochronous Transfer mechanism and Quality of Service (QoS) mechanism.

Aiming to resolve the foresaid problem, the PCI Special Interest Group (PCI-SIG) formed by AMD, IBM, HP, Intel, Microsoft and TI companies proposed the third generation input/output (3GIO) standard in 2002, i.e. PCI Express standard. In this standard, peer-to-peer serial transfer technologies are included and every group of PCI Express lines forms an independent transmission channel. In this way, the data transferred in the independent channels will not interfere with each other so that the transmission speed of the PCI Express interfaces can be much faster than that of the conventional PCI interfaces.

Every channel of the PCI Express interfaces can transmit 250 MB data per second. The PCI Express interfaces can have 32 channels at most. Hence, the transmission speed of the PCI Express interfaces can achieve 16 GB/sec that is much faster than that of the PCI interfaces. Therefore, the PCI Express interfaces can be used for Isochronous Transfer applications.

The PCI Express interface mainly includes a Root Complex unit of the North Bridge chip. The Root Complex unit of the PCI Express interface has multiple root ports for connecting with endpoint devices, i.e. computer peripherals. The Root Complex unit of the PCI Express interface is connected to a central processing unit (CPU) and a memory unit. The Root Complex unit is used to transfer data between the memory unit and the endpoint devices. In the PCI Express standard, the data transfer between the endpoint devices and the memory unit must use the root ports. The root complex unit must look up a time-based port arbitration table to control the data transfer time of the root ports. The port arbitration table is stored in a root complex register block (RCRB).

Reference is made to FIG. 1, which is a conventional PCI Express port arbitration table. The port arbitration table divides the data transfer time into multiple phases. In the PCI Express standard, the port arbitration table can have 32, 64, 128 or 256 phases. The port arbitration table shown in FIG. 1 has 64 phases, i.e. phase 0-phase 63. At every time phase, only one root port of the root complex unit can be used to access the memory unit. It means that the endpoint device connected to the chosen root port can transmit data to the memory unit or receive the data read from the memory unit. Thus, the data transfer can be proceeded from phase 0 to phase 63 orderly and cyclically. Every time phase corresponds to a root port and the manufacturer usually provides an initial assignment for the port arbitration table before the PCI Express interfaces are marketed. In general, the manufacturer assigns the time phases to the root ports fairly. For example, if the root complex unit has four root ports, the manufacturer may assign phase 0 to the first root port, phase 1 to the second root port, phase 2 to the third root port, phase 3 to the fourth root port, the phase 4 back to the first root port and so on.

Based on the PCI Express standard, the root ports of the root complex unit must perform data transfer of the memory unit according to the port arbitration table. At every time phase, only one root port can be used to read or write the memory unit. Even though there is no data that needs to be transferred via the chosen root port, the other root ports cannot be used to read or write the memory unit still. Obviously, this kind of scheme wastes the data transfer time, reduces the data transfer efficiency and has a low flexibility.

Therefore, aiming to resolve the problem mentioned above, the present invention provides a method for dynamically adjusting the data transfer order of PCI Express root ports. It can dynamically update the port arbitration table to adjust the data transfer order of the root ports. Hence, the present invention can increase the flexibility of the data transfer and improve the efficiency so that it can be used to resolve the foresaid problem.

### SUMMARY OF THE INVENTION

An objective of the present invention is to provide a method for dynamically adjusting the data transfer order of PCI Express root ports. It first reads the values of the available storage spaces of the storage unit of the PCI Express root ports recorded according to a flow control norm. Then, it can update the port arbitration table according to the values of the available storage spaces to dynamically adjust the data transfer order of the PCI Express root ports. In this way, the present invention can improve the flexibility and efficiency of the data transfer of the PCI Express root ports.

Another objective of the present invention is to provide a method for dynamically adjusting the data transfer order of PCI Express root ports. It first reads the values of the available storage spaces of the storage unit of the endpoints device connected to the PCI Express root ports, in which the values of the available storage spaces are recorded according to a flow control norm. Then, it can update the port arbitration table according to the values of the available storage spaces to dynamically adjust the data transfer order of the PCI Express root ports. In this way, the flexibility and efficiency of the data transfer of the PCI Express root ports can be improved.

For achieving the objectives above, the present invention provides a method for dynamically adjusting the data transfer order of the PCI Express root ports. The method is applied for a PCI Express interface having a root complex unit with multiple PCI Express root ports. The PCI Express root ports and the endpoint devices connected thereto have the first and second storage units respectively. The first storage units are used to receive and temporarily store the data sent from the endpoint devices while the second storage units are used to receive and store the data sent from the PCI Express root ports. The method of the present invention includes the steps as follows: reading the values of the available storage spaces of the first and second storage units; comparing the values of the available storage spaces of the first and second storage units to find the PCI Express root ports with larger data transfer volume; and updating a port arbitration table to adjust the data transfer order of the PCI Express root ports to make the PCI Express root ports with larger data transfer volume have higher priority for data transfer.

Numerous additional features, benefits and details of the present invention are described in the detailed description, which follows.

### BRIEF DESCRIPTION OF THE DRAWINGS

The foregoing aspects and many of the attendant advantages of this invention will be more readily appreciated as the same becomes better understood by reference to the following detailed description, when taken in conjunction with the accompanying drawings, wherein:

FIG. 1 is a conventional PCI Express port arbitration table;

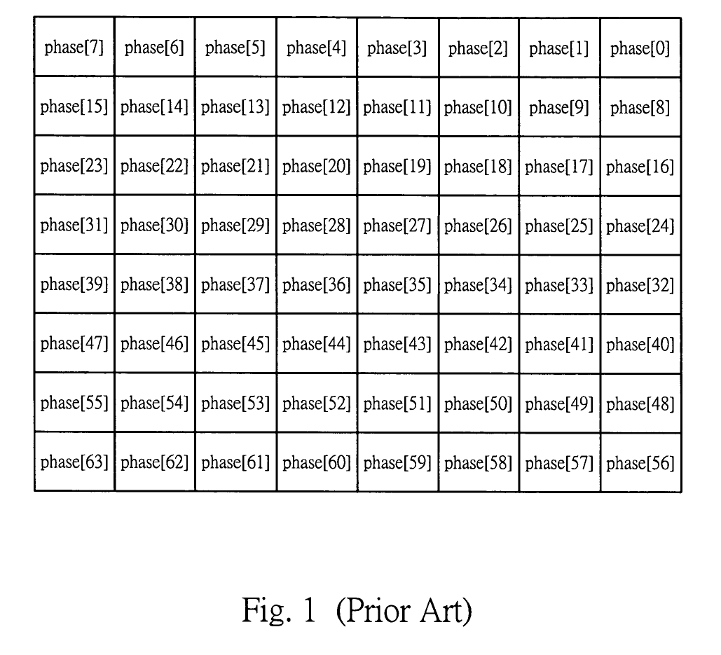

FIG. 2 is a block diagram of a PCI Express interface in accordance with a preferred embodiment of the present invention;

FIG. 3 is a flow chart of a preferred embodiment in accordance with the present invention; and

FIG. 4 is a flow chart of another preferred embodiment in accordance with the present invention.

### DETAILED DESCRIPTION OF PREFERRED EMBODIMENTS

The main concept of the present invention is to use the flow control norm of the PCI Express standard to find the root ports with larger data transfer volumes. Thereby, the present invention can dynamically update the port arbitration table to make the root ports with larger data transfer volumes have a high priority for data transfer so that the data transfer of the root ports can have better flexibility and higher efficiency.

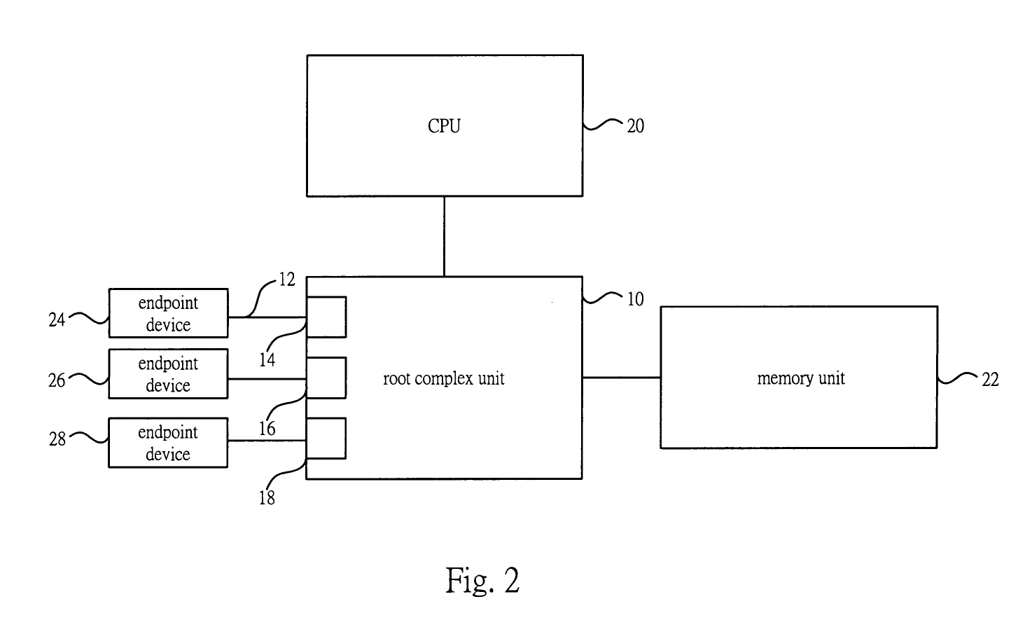

Reference is made to FIG. 2, which is a block diagram of a PCI Express interface in accordance with a preferred embodiment of the present invention. As shown in FIG. 2, the PCI Express interface includes a root complex unit 10, which is respectively connected to a CPU 20, a memory unit 22 and multiple endpoint devices 24, 26 and 28. Therein, the endpoint devices 24, 26 and 28 are connected to root ports 14, 16 and 18 of the root complex unit 10 via a PCI Express bus 12. When the endpoint devices 24, 26 and 28 need to transmit data to the memory unit 22, they must transmit the data to first storage units of the corresponding root ports 14, 16 and 18 in advance to store the data temporarily. Then, the root complex unit 10 orderly transmits the data stored in the first storage units of the root ports 14, 16 and 18 according to the root arbitration table. Similarly, when the root ports 14, 16 and 18 need to be used to transmit data from the memory unit 22 to the endpoint devices 24, 26 and 28, the data are orderly transmitted to the second storage units of the endpoint devices 24, 26 and 28 according to the root arbitration table.

In the PCI Express standard, a flow control norm is defined to confirm that the storage units of the receiving ends can accommodate the data transmitted between the root ports 14, 16, 18 and the endpoint devices 24, 26, 28. According to the flow control norm, all of the endpoint devices 24, 26, 28 and the root complex unit 10 have flow control circuits to monitor the available storage spaces of the first and second storage units. Thus, when the transmitting end needs to transmit data to the receiving end, it can know whether the receiving end has enough available storage space to store the data. The transmitting end transmits the data only when it confirms the receiving end has enough available storage space.

In the present invention, the flow control circuits record the values of the available storage spaces of the storage units in the registers of the root ports 14, 16 and 18. Thus, the present invention can access the values recorded in the registers of the root ports 14, 16 and 18 to check the available storage spaces of the first and second storage units. Furthermore, the present invention can also find the root ports with larger data transfer volume in this way. For example, suppose that the endpoint device 24 is a display card and the computer system is executing a 3D drawing program or a 3D video game. There must be a large number of data transferred between the endpoint device 24 and the memory unit 22. At this situation, the available storage spaces of the corresponding first and second storage units must be smaller. That means the root port 14 has larger data transfer volume. Therefore, the present invention can find the root ports with larger data transfer volume by comparing the values of the available storage spaces of the storage units.

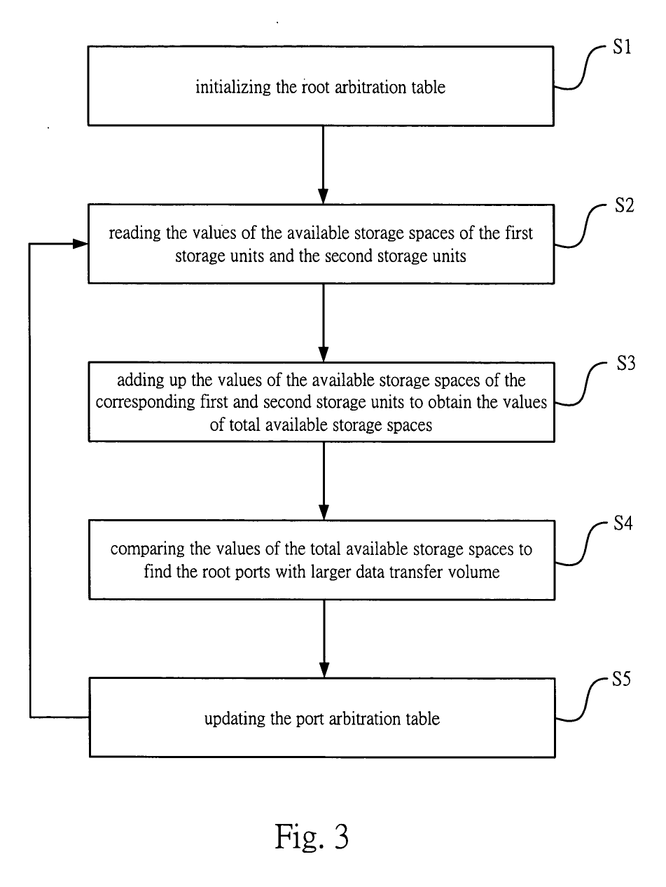

Reference is made to FIG. 3, which is a flow chart of a preferred embodiment in accordance with the present invention. As shown in FIG. 3, when the computer system is turned on, it first initializes the root arbitration table to recover the preset values of the same (step S1). At this moment, the flow control circuits checks the available storage spaces of the first storage units and the second storage units and records their values in the corresponding root ports 14, 16 and 18 respectively. After that, the present invention reads the values of the available storage spaces of the first storage units and the second storage units (step S2). Subsequently, the present invention compares the values of the total available storage spaces of the first storage units and the second storage units to find the root ports with larger data transfer volume, and the comparative process is showed as step S3 and Step S4. The data transfer volume is larger when the value of the total available storage space is smaller. The step S3 respectively adds up the values of the available storage spaces of the corresponding first and second storage units to obtain the values of total available storage spaces, such as adding up a first value of the available storage space of each PCI Express root port and a second value of the available storage space of the correspondingly endpoint device to obtain a third value of a total available storage space respectively. The Step S4 compares the values of the total available storage spaces to find the root ports with larger data transfer volume. Finally, the present invention sorts transmission priorities of the root ports. That is to update the port arbitration table to adjust the data transfer order of the root ports so that the root ports with larger data transfer volume can have a higher priority for data transfer (step S5). For example, the present invention can update the port arbitration table to make the root ports with larger data transfer volume able to transfer data at most of the time phases.

As above description, the present invention can dynamically update the port arbitration table to adjust the data transfer order of the root ports according to their data transfer volumes. In this way, the present invention can avoid the root ports that needn't transmit data occupy the time phases. Thus, the present invention can improve the flexibility and efficiency for data transfer. Furthermore, the present invention can add a step before step S2. That is to detect the signals sent from the root ports for data transfer permission. If there is only one root port sending the signal, the present invention can directly update the port arbitration table to allow this root port to transmit data without performing steps S2-S4.

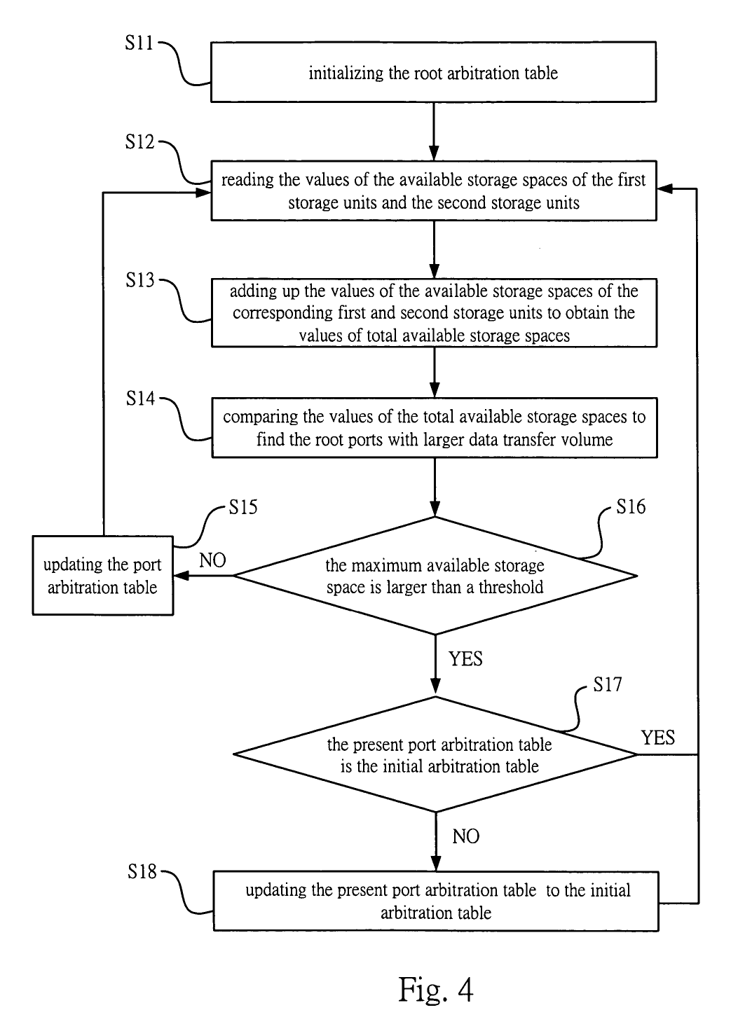

Reference is made to FIG. 4, which is a flow chart of another preferred embodiment in accordance with the present invention. The difference between this embodiment and the above one is that all the root ports only have a few data ready for transmission. Thus, the root ports only need to transfer their data according to the original port arbitration table. Hence, in step S114 of this embodiment, the present invention compares the total available storage spaces to find the root port with the maximum available storage space. After that, the present invention determines whether the maximum available storage space is larger than a threshold (step S16). If the maximum available storage space is smaller than the threshold, the present invention updates the port arbitration table (step S15). Otherwise, if the maximum available storage space is larger than the threshold, it means that even the root port with the maximum available storage space doesn't have much data ready for transmission. At this situation, the root ports only need to transfer data according to the original port arbitration table. Hence, the present invention simply determines whether the present port arbitration table is the initial arbitration table (step S17). If yes, go back to step S12. Otherwise, the present invention updates the present port arbitration table to the initial arbitration table (step S18).

The above embodiments use values of the total available storage spaces of the first and second storage units to determine the data transfer volume of the root ports 14, 16 and 18. However, it should be noted that the present invention could also be implemented by using the values of the available storage spaces of the first storage units or the second storage units only. Besides, the present invention can also change the root arbitration table according to the priority of the endpoint devices 24, 26, 28 respectively connected to the root ports 14, 16, 18.

Summing up, the present invention provides a method for dynamically adjusting the data transfer order of PCI Express root ports. It uses the values of the available storage spaces of the root ports and the endpoint ports that are recorded according to the flow control norm to find the root ports with larger data transfer volumes and thereby update the port arbitration table to adjust the data transfer order of the root ports. In this way, the present invention can make the root ports with larger data transfer volumes have a higher priority for data transfer. Thus, it can prevent the root ports with no data ready for transfer from occupying the data transmission time so that the data transfer of the root ports can have better flexibility and higher efficiency.

Although the present invention has been described with reference to the preferred embodiment thereof, it will be understood that the invention is not limited to the details thereof. Various substitutions and modifications have been suggested in the foregoing description, and other will occur to those of ordinary skill in the art. Therefore, all such substitutions and modifications are embraced within the scope of the invention as defined in the appended claims.

What is claimed is:

1. A method for dynamically adjusting a data transfer order of Peripheral Component Interconnect Express (PCI Express) root ports, the method being applied for a PCI Express interface having a root complex unit with the PCI Express root ports, the PCI Express root ports respectively connecting to endpoint devices and having first storage units to receive and temporarily store data sent from the endpoint devices, the endpoint devices respectively having second storage units to receive and store data sent from the PCI Express root ports, the method comprising:
reading first values of available storage spaces of the first storage units and second values of available storage spaces of the second storage units, wherein the first values and the second values are recorded according to a flow control norm;
comparing the first values of the available storage spaces of the first storage units and the second values of the available storage spaces of the second storage units to find the PCI Express root ports with larger data transfer volume; and
updating a port arbitration table to adjust the data transfer order of the PCI Express root ports to make the PCI Express root ports with larger data transfer volume have higher priority for data transfer.

2. The method as claimed in claim 1, wherein the step of comparing the first values of the available storage spaces of the first storage units and the second values of the available storage spaces of the second storage units further comprises:
adding up the first values of the available storage spaces of the first storage units and the second values of the available storage spaces of the second storage units corresponding to the same PCI Express root ports to obtain third values of total available storage spaces of the first storage units and the second storage units; and
comparing the third values of total available storage spaces of the first storage units and the second storage units to find the PCI Express root ports with the larger data transfer volume.

3. The method as claimed in claim 1, wherein the step of reading the first values of the available storage spaces of the first storage units and the second values of the available storage spaces of the second storage units is performed by reading the first and second values recorded in the PCI Express root ports.

4. The method as claimed in claim 1, wherein before the step of reading the first values of the available storage spaces of the first storage units and the second values of the available storage spaces of the second storage units is performed, the method further comprises:
detecting signals sent from the PCI Express root ports for data transfer permission;
wherein when only one of the PCI Express root ports sends out the signal asking for the data transfer permission, the port arbitration table is updated to make the one of the PCI Express root ports has higher priority for data transfer.

5. The method as claimed in claim 1, wherein the PCI Express root ports are used to transmit ready data of the endpoints devices connected thereto so as to pass the data of the endpoints devices to a memory connected to the root complex unit; and the PCI Express root ports are also used to pass data of the memory to the endpoints devices.

6. A method for dynamically adjusting a data transfer order of PCI Express root ports, the method being applied for a PCI Express interface having a root complex unit with the PCI Express root ports, the PCI Express root ports respectively connecting to endpoint devices and having storage units to receive and temporarily store data sent from the endpoint devices, the method comprising:
reading values of available storage spaces of the storage units, wherein the values of the available storage spaces of the storage units are recorded according to a flow control norm;
comparing the values of the available storage spaces of the storage units to find the PCI Express root ports with larger data transfer volume; and
updating a port arbitration table to adjust the data transfer order of the PCI Express root ports to make the PCI Express root ports with larger data transfer volume have higher priority for data transfer.

7. The method as claimed in claim 6, wherein the step of reading the values of the available storage spaces of the storage units is performed by reading the values of the available storage spaces of the storage units recorded in the PCI Express root ports.

8. The method as claimed in claim 6, wherein before the step of reading the values of the available storage spaces of the storage units is performed, the method further comprises:
detecting signals sent from the PCI Express root ports for data transfer permission;
wherein when only one of the PCI Express root ports sends out the signal asking for the data transfer permission, the port arbitration table is updated to make the one of the PCI Express root ports has higher priority for data transfer.

9. The method as claimed in claim 6, wherein the PCI Express root ports are used to transmit ready data of the endpoints devices connected thereto so as to pass the data of the endpoints devices to a memory connected to the root complex unit.

10. A method for dynamically adjusting a data transfer order of PCI Express root ports, the method being applied for a PCI Express interface having a root complex unit with the PCI Express root ports, the PCI Express root ports respectively connecting to endpoint devices, the endpoint devices respectively having storage units to receive and store data sent from the PCI Express root ports, the method comprising:
reading values of available storage spaces of the storage units, wherein the values of the available storage spaces of the storage units are recorded according to a flow control norm;
comparing the values of the available storage spaces of the storage units to find the PCI Express root ports with larger data transfer volume; and
updating a port arbitration table to adjust the data transfer order of the PCI Express root ports to make the PCI Express root ports with larger data transfer volume have higher priority for data transfer.

11. The method as claimed in claim 10, wherein the step of reading the values of the available storage spaces of the storage units is performed by reading the values recorded in the PCI Express root ports.

12. The method as claimed in claim 10, wherein before the step of reading the values of the available storage spaces of the storage units is performed, the method further comprises:
detecting signals sent from the PCI Express root ports for data transfer permission;
wherein when only one of the PCI Express root ports sends out the signal asking for the data transfer permission, the port arbitration table is updated to make the one of the PCI Express root ports has higher priority for data transfer.

13. The method as claimed in claim 10, wherein the PCI Express root ports are used to transmit data of a memory connected to the root complex unit so as to pass the data of the memory to the endpoints devices.

14. A method for dynamically adjusting a data transfer order of Peripheral Component Interconnect Express (PCI Express) root ports, the PCI Express root ports respectively connecting to endpoint devices, the method comprising:
adding up a first value of an available storage space of each PCI Express root port and a second value of an available storage space of the correspondingly endpoint device to obtain a third value of a total available storage space respectively; and
sorting transmission priorities of the PCI Express root ports according to the third values of total available storage spaces, wherein the PCI Express root port with a smallest third value of total available storage space has priority over all others.

15. The method as claimed in claim 14, wherein before the step of adding up a first value of an available storage space of each PCI Express root port and a second value of an available storage space of the correspondingly endpoint device to obtain a third value is performed, the method further comprises:
reading first values of available storage spaces of the PCI Express root ports and second values of available storage spaces of the correspondingly endpoint devices, wherein the first values and the second values are recorded according to a flow control norm.

16. The method as claimed in claim 15, wherein the step of reading the first values of the available storage spaces of the PCI Express root ports and the second values of the available storage spaces of the correspondingly endpoint devices is performed by reading the first and second values recorded in the PCI Express root ports.

17. The method as claimed in claim 14, wherein the PCI Express root ports respectively having first storage units to receive and temporarily store data sent from the endpoint devices, the endpoint devices respectively having second storage units to receive and store data sent from the PCI Express root ports, the step of adding up a first value of an available storage space of each PCI Express root port and a second value of an available storage space of the correspondingly endpoint device to obtain a third value is performed by adding up the first value of the available storage space of each first storage unit and second value of the available storage space of the correspondingly second storage unit respectively.

18. The method as claimed in claim 14, wherein before the step of adding up a first value of an available storage space of each PCI Express root port and a second value of an available storage space of the correspondingly endpoint device to obtain a third value is performed, the method further comprises:
detecting signals sent from the PCI Express root ports for data transfer permission;
wherein when only one of the PCI Express root ports sends out the signal asking for the data transfer permission, making the one of the PCI Express root ports has transmission priority over all others.

19. The method as claimed in claim 14, wherein the step of sorting transmission priorities of the PCI Express root ports according to the third values of total available storage spaces is performed by updating a port arbitration table to adjust the data transfer order of the PCI Express root ports.

20. The method as claimed in claim 14, wherein the PCI Express root ports are used to transmit ready data of the endpoints devices connected thereto so as to pass the data of the endpoints devices to a memory connected to the root complex unit; and the PCI Express root ports are also used to pass data of the memory to the endpoints devices.
